(19) United States
(12) Patent Application Publication
(10) Pub. No.: US 2008/0155149 A1
(43) Pub. Date: Jun. 26, 2008

(54) MULTI-PATH REDUNDANT ARCHITECTURE FOR FAULT TOLERANT FULLY BUFFERED DIMMS

(76) Inventors: Daniel N. de Araujo, Cedar Park, TX (US); Moises Cases, Austin, TX (US); Erdem Matoglu, Austin, TX (US); Nam H. Pham, Round Rock, TX (US)

Correspondence Address: HOFFMAN WARNICK & DALESSANDRO LLC, 75 STATE STREET, 14TH FLOOR, ALBANY, NY, 12207, US

(21) Appl. No.: 11/613,363

(22) Filed: Dec. 20, 2006

(51) Int. Cl. G06F 13/16

(52) U.S. Cl. 710/107; 710/310

(57) ABSTRACT

The present invention is directed to a multi-path redundant architecture for fault tolerant fully buffered dual inline memory modules (FB-DIMMs). The architecture includes: a FB-DIMM channel including a plurality of DIMM modules and a memory controller; a bidirectional serial memory bus for coupling the memory controller and the plurality of DIMM modules of the FB-DIMM channel in a first connection order; and a redundant bidirectional serial memory bus for coupling the memory controller and the plurality of DIMM modules of the FB-DIMM channel in a second connection order

### BACKGROUND OF THE INVENTION

1. Field of the Invention

The present invention generally relates to memory systems. More specifically, the present invention is directed to a multi-path redundant architecture for fault tolerant fully buffered dual inline memory modules (FB-DIMMs).

2. Related Art

FB-DIMM is a memory architecture that combines the high-speed internal architecture of DDR2 memory with a point-to-point serial memory interface, which links each FB-DIMM module together in a chain. An illustrative FB-DIMM topology in accordance with the related art is provided in FIG. 1. While FB-DIMM provides electrical advantages in terms of loading and signaling, it also raises an issue regarding DIMM failure.

A more detailed depiction of an illustrative FB-DIMM channel 10 in accordance with the related art is provided in FIG. 2. The FB-DIMM channel 10 includes a plurality of DIMM modules 12A, 12B, 12C, 12D, a memory controller 14, and a high-speed bidirectional serial memory bus 16. The high-speed bi-directional serial memory bus 16 uses pairs of wires to enable a technique called differential transmission to ensure accurate data transmission. With differential transmission, a signal is transmitted on both strands of a wire pair: one with the standard signal and one with the inverted signal. Each DIMM module 12A, 12B, 12C, 12D includes a built-in Advanced Memory Buffer (AMB) 18, which manages the DRAM 20 read and write operations of the DIMM module while also handling all communications across the bidirectional serial memory bus 16 to the memory controller 14. Each path of the bidirectional serial memory bus 16 employs differential signaling.

If the first DIMM module 12A in the FB-DIMM channel 10 fails for some reason (indicated by the large “X”), communication to subsequent DIMM modules 12B, 12C, 12D in the FB-DIMM channel 10 via the bidirectional serial memory bus 16 can be lost (indicated by the gray arrows), since the DIMM modules 12B, 12C, 12D depend on the failed DIMM module 12A to retransmit data back to the memory controller 14.

### SUMMARY OF THE INVENTION

The present invention is directed to a multi-path redundant architecture for fault tolerant fully buffered dual inline memory modules (FB-DIMMs). The invention leverages the technology, volume and cost savings provided by standard FB-DIMM technology and components, while providing an enhanced mode which addresses the shortfalls of the FB-DIMM architecture. This is accomplished by providing a complete, second control/data path in the reverse connection order of the bidirectional serial memory bus, which can be used to access working DIMMS in case of failure.

A first aspect of the present invention is directed to a multi-path redundant architecture for fault tolerant fully buffered dual inline memory modules (FB-DIMMs), comprising: a FB-DIMM channel including a plurality of DIMM modules and a memory controller; a bidirectional serial memory bus for coupling the memory controller and the plurality of DIMM modules of the FB-DIMM channel in a first connection order; and a redundant bidirectional serial memory bus for coupling the memory controller and the plurality of DIMM modules of the FB-DIMM channel in a second connection order.

A second aspect of the present invention is directed to a memory system, comprising: a fault tolerant fully buffered dual inline memory module (FB-DIMM) channel including a plurality of DIMM modules and a memory controller; a bidirectional serial memory bus for coupling the memory controller and the plurality of DIMM modules of the FB-DIMM channel in a first connection order; and a redundant bidirectional serial memory bus for coupling the memory controller and the plurality of DIMM modules of the FB-DIMM channel in a second connection order.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts an illustrative FB-DIMM topology in accordance with the related art.

FIG. 2 depicts an illustrative FB-DIMM channel in accordance with the related art.

FIG. 3 depicts an illustrative multi-path FB-DIMM channel in accordance with an embodiment of the present invention.

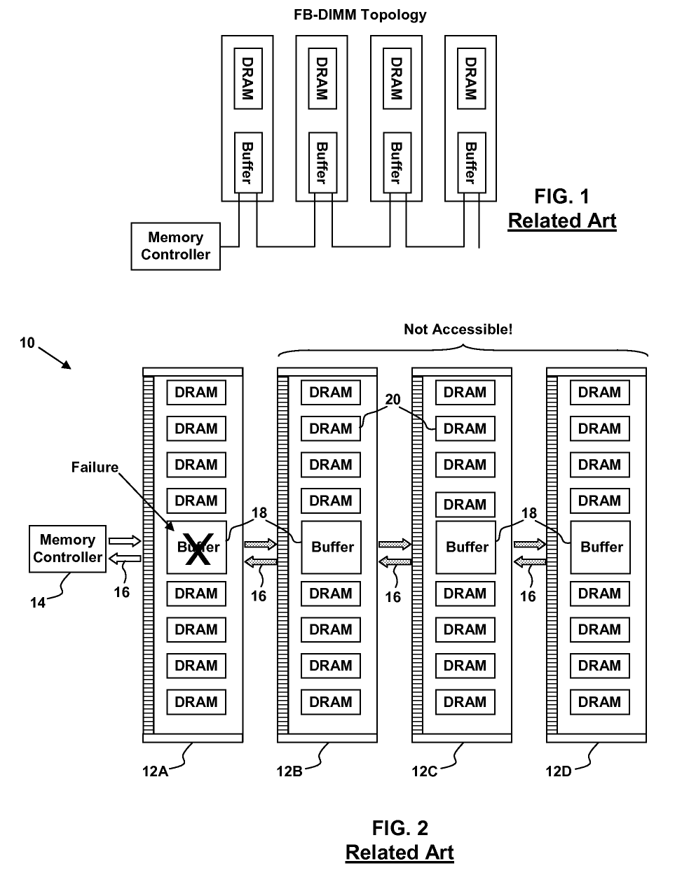

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, the present invention is directed to a multi-path redundant architecture for fault tolerant fully buffered dual inline memory modules (FB-DIMMs). The invention leverages the technology, volume and cost savings provided by standard FB-DIMM technology and components, while providing an enhanced mode which addresses the shortfalls of the FB-DIMM architecture. This is accomplished by providing a complete, second control/data path in the reverse connection order of the bidirectional serial memory bus, which can be used to access working DIMMS in case of failure.

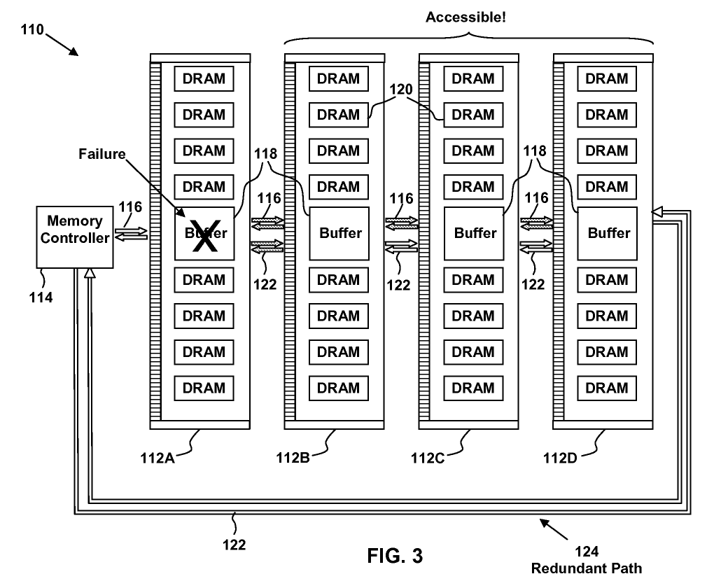

FIG. 3 depicts an illustrative multi-path FB-DIMM channel 110 in accordance with an embodiment of the present invention. As in FIG. 2, the FB-DIMM channel 110 of the present invention includes a plurality of DIMM modules 112A, 112B, 112C, 112D, and a memory controller 114. Each DIMM module 112A, 112B, 112C, 112D includes a built-in Advanced Memory Buffer (AMB) 118, which manages the DRAM 120 read and write operations of the DIMM module while also handling all communications to/from the memory controller 114.

In accordance with an embodiment of the present invention, single-ended signaling is used instead of the differential signaling of the prior art to double the number of control/data paths. As shown in FIG. 3, the multi-path FB-DIMM channel 110 includes a first bidirectional serial memory bus 116 and a second bidirectional serial memory bus 122.

The first bidirectional serial memory bus 116 uses single-ended signaling and couples the memory controller 114 and the DIMM modules 112A, 112B, 112C, 112D in a chain in a forward connection order (memory controller 114→DIMM module 112A→DIMM module 112B→DIMM module 112C→DIMM module 112D). The second bidirectional serial memory bus 122, however, is configured such that a redundant path 124 is provided between the last DIMM module 112D and the memory controller 114. In this case, the second bidirectional serial memory bus 122, which again uses single-ended signaling, couples the DIMM modules 112A, 112B, 112C, 112D and the memory controller 114 in a chain in a reverse connection order (memory controller 114→DIMM module 112D→DIMM module 112C→DIMM module 112B at DIMM module 112A). Hybrid, programmable I/O or other suitable technique can be used to provide the single-ended signaling. The redundant path 124 requires no additional signals, since all differential control/data signals have been broken into two single-ended signals.

If the first DIMM module 112A in the FB-DIMM channel 110 fails for some reason (indicated by the large “X” in FIG. 3), communication to subsequent DIMM modules 112B, 112C, 112D in the FB-DIMM channel 110 via the first bi-directional serial memory bus 116 may be cut off (indicated by the gray arrows), since the DIMM modules 112B, 112C, 112D depend on the failed DIMM module 112A to retransmit data back to the memory controller 114. Now, however, in accordance with the present invention, access to the DIMM modules 112B, 112C, 112D is still available via the second bidirectional serial memory bus 122. To this extent, by providing a complete, second control/data path in a reverse connection order, the working DIMM modules 112B, 112C, 112D can still be accessed in case of the failure of the DIMM module 112A.

As another example, if the second DIMM module 112B in the FB-DIMM channel 110 fails for some reason, communication to subsequent DIMM modules 112C, 112D in the FB-DIMM channel 110 via the first bi-directional serial memory bus 116 may be cut off, since the DIMM modules 112C, 112D depend on the failed DIMM module 112B to retransmit data back to the memory controller 114. However, in accordance with the present invention, access to the DIMM modules 112C, 112D is still available via the second bidirectional serial memory bus 122. Access to the DIMM module 112A is available via the first bi-directional serial memory bus 116.

During normal operation, the redundant path 124 could be used to improve performance since it provides an alternative path to the DIMMs. A single controller using, for example, a hybrid I/O, could support both a normal FB-DIMM channel architecture and a FB-DIMM channel architecture that includes the redundant path 124. This would enable the same chip to be used in a low end environment with standard FB-DIMMs as well as a higher-end environment with the redundant path 124, which supports the single-ended signaling and the dual channel failover of the present invention.

The foregoing description of the embodiments of this invention has been presented for purposes of illustration and description. It is not intended to be exhaustive or to limit the invention to the precise form disclosed, and many modifications and variations are possible.

What is claimed is:

1. A multi-path redundant architecture for fault tolerant fully buffered dual inline memory modules (FB-DIMMs), comprising:
a FB-DIMM channel including a plurality of DIMM modules and a memory controller;
a bidirectional serial memory bus for coupling the memory controller and the plurality of DIMM modules of the FB-DIMM channel in a first connection order; and
a redundant bidirectional serial memory bus for coupling the memory controller and the plurality of DIMM modules of the FB-DIMM channel in a second connection order.

2. The architecture of claim 1, wherein the first and second bi-directional serial memory busses use single-ended signaling.

3. The architecture of claim 1, wherein the second connection order is opposite that of the first connection order.

4. The architecture of claim 1, wherein the bidirectional serial memory bus couples the memory controller to the first DIMM module in the FB-DIMM channel, and wherein the redundant bidirectional serial memory bus couples the memory controller to the last DIMM module in channel in the FB-DIMM channel.

5. A memory system, comprising:
a fault tolerant fully buffered dual inline memory module (FB-DIMM) channel including a plurality of DIMM modules and a memory controller;
a bi-directional serial memory bus for coupling the memory controller and the plurality of DIMM modules of the FB-DIMM channel in a first connection order; and
a redundant bidirectional serial memory bus for coupling the memory controller and the plurality of DIMM modules of the FB-DIMM channel in a second connection order.

6. The memory system of claim 5, wherein the first and second bidirectional serial memory busses use single-ended signaling.

7. The memory system of claim 5, wherein the second connection order is opposite that of the first connection order.

8. The memory system of claim 5, wherein the bidirectional serial memory bus couples the memory controller to the first DIMM module in the FB-DIMM channel, and wherein the redundant bi-directional serial memory bus couples the memory controller to the last DIMM module in channel in the FB-DIMM channel.
